(19) United States
(12) Patent Application Publication
(10) Pub. No.: US 2012/0161367 A1
(43) Pub. Date: Jun. 28, 2012

(54) MOLD BASE FOR URETHANE CASTING PROCESS

(75) Inventors: Hyun J. Kim, Carlsbad, CA (US); Jaerim Kim, San Diego, CA (US); Kwangjin Choi, Cheongju (KR)

(73) Assignee: Taylor Made Golf Company, Inc.

(21) Appl. No.: 13/308,114

(22) Filed: Nov. 30, 2011

Related U.S. Application Data
(60) Provisional application No. 61/427,739, filed on Dec. 28, 2010.

(51) Int. Cl. B29C 33/20

(52) U.S. Cl. 264/402; 425/3

(57) ABSTRACT

A mold design with magnetic locking components for a urethane casting process can allow for several advantages over conventional mechanical locking mechanisms for holding two mold halves together. The magnetic locking components can be permanent magnetic components, electromagnetic components, or a combination of the two. A switch can allow for magnetizing and demagnetizing of the magnetic locking components, thereby respectively providing and releasing a mold holding force at the appropriate times of, for example, a urethane casting process. The magnetic locking components can be used with single or multi-cavity molds.

### CROSS REFERENCE TO RELATED APPLICATION

This application claims the benefit of U.S. Provisional Patent Application No. 61/427,739, filed Dec. 28, 2010, which is hereby incorporated by reference.

### FIELD

The disclosure relates to a mold design with magnetic locking components for a urethane casting process.

### BACKGROUND

Conventional cavity molds (e.g., single or multi-cavity molds) for making, among other things, golf balls, are subject to many drawbacks. For example, current multi-cavity molds typically employ mechanical locking mechanisms to hold two halves of the mold together. Such mechanical locking mechanisms can disadvantageously fail to distribute the holding force evenly over the two mold halves. Such uneven force distribution can result in various ball defects, such as imperfect concentricity and seam line tears.

Additionally, conventional mechanical locking mechanisms can be bulky, requiring several mechanical locking components located in the bottom half of the mold (e.g., below the cavity plates), between rows of mold cavities. As a result, the entire mold base must be enlarged in order to accommodate the locking mechanisms. Larger mold bases are disadvantageous because the larger the mold base footprint or the thicker the overall height of the mold, the higher the energy cost for heating and cooling the mold cavities. Larger mold bases can also disadvantageously require longer cycle times during casting. Additionally, larger molds require more space in the production line, thus decreasing the number of units that can be produced in a certain area.

Other types of locking mechanisms have been developed for injection molding processes. For example, U.S. Pat. No. 6,619,940 discloses a method and device for electromagnetically clamping molds of an injection molding machine. Injection molding processes typically require a very high force (e.g., over 15,000 psi). The method and device described in the '940 Patent is not applicable to casting techniques due to the complexity of casting processes. For example, typical casting processes can involve 40 or 60 or more mold bases moving simultaneously through multiple stations, to which the device and methods disclosed in the '940 patent would not be amenable. Therefore, a need still remains for an improved locking mechanism for casting processes such as urethane casting processes.

### SUMMARY

The present disclosure describes a novel mold design which can address these and other disadvantages in the prior art. For example, the present mold designs can reduce the overall size of mold bases and can more evenly distribute the hold forces while the mold halves are being pressed together. Further, present embodiments can create larger areas of locking while not increasing the overall size of the mold (some embodiments can allow for reduced mold size as compared to conventional molds), which can enable more even application of the locking force throughout the two mold halves. Disclosed embodiments can comprise, for example, an electromagnetic or permanent magnetic locking device that can improve efficiency of heating and cooling of the mold halves. Disclosed embodiments can also allow for a decreased cycle time as compared to conventional molds. Additionally, smaller or reduced profile molds with simpler designs can also reduce costs associated with maintenance and can be easier for users to handle and maintain. These benefits can also increase the overall lifetime of the mold. Use of a magnetic locking device can also reduce production times in that locking and unlocking of the mold halves is essentially immediate. Thus, the process time for mold assembly and demolding can be reduced as compared to conventional mechanical locking components, which require more time to lock and unlock the mold halves.

Embodiments of a disclosed mold design can comprise two mold halves held together with magnetic (e.g., permanent magnetic or electromagnetic) locking mechanisms. The molds can be single-cavity molds or multi-cavity molds. The electromagnetic locking components can be positioned along the sides of the mold, away from the center line of the cavity. This positioning can contribute to the quality of the part or product (e.g., golf balls) produced in the mold. Disclosed embodiments can also reduce the size (e.g., thickness, or overall height) of the mold base, as compared to prior art mold designs, thereby reducing the amount of energy required for heating and cooling the mold halves.

In one embodiment, the mold is a single cavity mold for a urethane casting process for making, for example, golf balls. In another embodiment, the mold is a multi-cavity mold for urethane casting of a plurality of golf balls simultaneously.

In some embodiments, locking components assembled in the top and bottom mold halves can be magnetized at the mold assembly station, thereby effectively locking the mold. The electromagnetic force can be kept as strong as necessary for a period of time until the molding process is complete, at which point the two mold halves can be demagnetized and released.

Embodiments of the present mold design can decrease the amount of mold maintenance required as compared to prior art designs, because the electromagnetic locking mechanism can reduce or eliminate mechanical motion (e.g., the number of moving parts) required for locking and unlocking the mold halves.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exploded perspective view of a two-part single cavity mold.

FIG. 2 is a perspective view of the assembled two-part single cavity mold of FIG. 1.

FIG. 3 is a bottom plan view of the upper half of the two-part single cavity mold shown in FIGS. 1-2.

FIG. 4 is an exploded perspective view of a two-part multi-cavity mold.

FIG. 5 is a bottom plan view of the upper half of the two-part multi-cavity mold shown in FIG. 4.

FIG. 6 is a side elevation view of the upper half of the two-part multi-cavity mold shown in FIG. 4.

FIG. 7 is a top plan view of the lower half of the two-part multi-cavity mold shown in FIG. 4.

FIG. 8 is a side elevation view of the lower half of the two-part multi-cavity mold shown in FIG. 4.

FIG. 9 is a schematic block diagram of one embodiment of an electromagnetic locking system that can be used with described single and multi-cavity molds.

### DETAILED DESCRIPTION

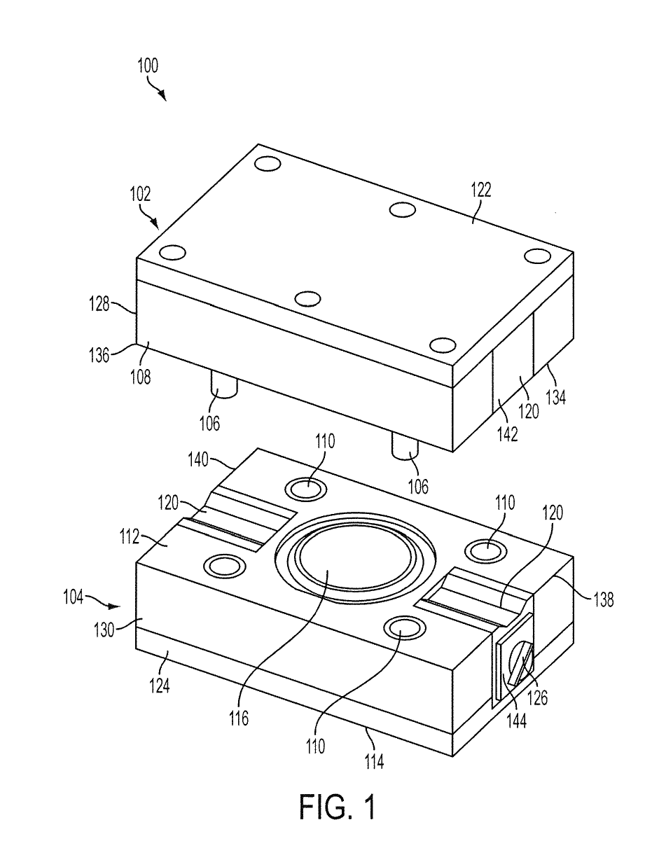

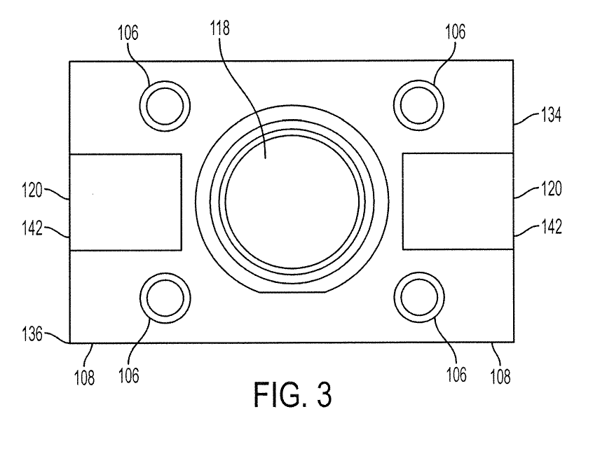

One embodiment of a single cavity mold 100 is illustrated in FIGS. 1-3. The mold 100 can comprise an upper mold half 102 and a lower mold half 104. Terms such as “upper,” “top,” “bottom,” and “lower” are used merely for convenience with reference to the figures, and are not meant to be limiting (e.g., the “upper” mold half may be positioned below the “lower” mold half). Generally, the upper mold half 102 can include a top mold plate 122 that can be coupled to (e.g., by fasteners, welding, adhesives, or the like) an upper cavity plate 128 that houses an upper cavity half 118 (best seen in FIG. 3). The lower mold half 104 can include a bottom mold plate 124 that can be coupled to a lower cavity plate 130 that houses a lower cavity half 116.

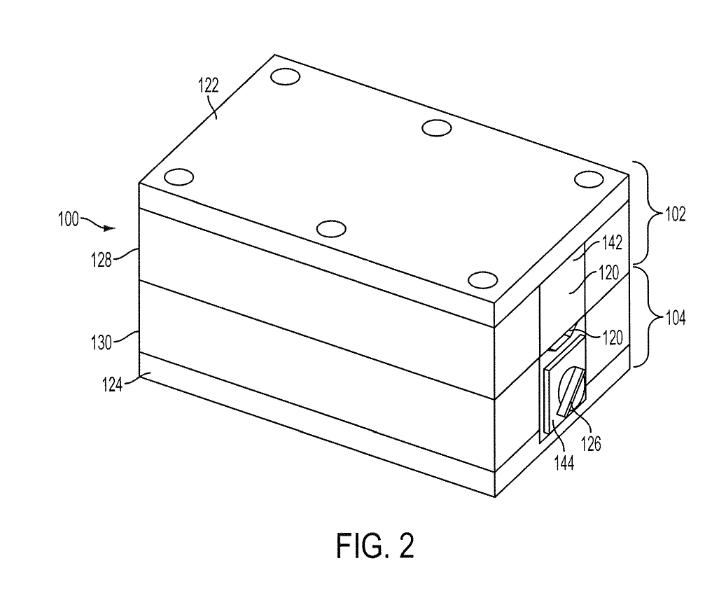

Upper mold half 102 and lower mold half 104 are configured to engage with one another, as shown in FIG. 2. For example, upper mold half 102 can comprise a plurality (e.g., 2, 3, 4 or more) of projecting pins or pegs 106 extending from a mold face 108 towards the lower mold half 104. The lower mold half 104 can comprise corresponding recesses 110 extending from a mold face 112 towards the outer surface 114 of the lower mold half 104, such that the recesses extend at least partially through the thickness of the lower mold half 104.

The mold 100 creates an internal cavity (e.g., a spherical cavity for a golf ball) when the two mold halves 102, 104 are engaged with one another. For example, when the mold halves 102, 104 are engaged with one another, the lower cavity (e.g., a hemispherical cavity) 116 of the lower mold half 104 can be aligned with the upper cavity 118 (e.g., a hemispherical cavity identical to the lower cavity 116) of the upper mold half 102, so as to form a spherical cavity. For clarity, the drawings show smooth cavity surfaces of upper and lower cavities 116, 118. However, the cavity surfaces can be provided with any desired texture or pattern, as useful for the particular part being cast. For example, the cavity surfaces can include an inverse dimple pattern for forming dimples on the surface of a golf ball formed within the cavities 116, 118.

Additionally, each of the mold halves 102, 104 can comprise one or more magnetic locking components 120 that can be used to create a sufficient holding force to hold the mold halves 102, 104 together (e.g., engaged with one another) during the molding process. As used herein, the term “magnetic locking component” includes the use of permanent magnet components, electromagnetic components, and combinations thereof.

As shown in FIGS. 1-3, the magnetic locking components 120 can be positioned in the periphery of the mold 100. For example, a magnetic locking component 120 can be positioned near each of a first end 134 and second end 136 of the upper mold half 102, and near a first end 138 and a second end 140 of the lower mold half 104. In this manner, no locking components are positioned across the center line of the cavities 116, 118. In fact, in the embodiments shown in FIGS. 1-3, the magnetic locking components do not interfere with (e.g., do not overlap) the cavities 116, 118 at all. This positioning can reduce defects in the cast product and can also contribute to a more even holding force distribution through the mold halves 102, 104.

As best seen in FIG. 1, the magnetic locking components 120 can include one or more upper locking components 142 positioned in or on the upper mold half 102 and one or more lower locking components 144 positioned in or on the lower mold half 104. In the embodiment shown in FIGS. 1-3, the upper locking components 142 can comprise a ferrous (e.g., capable of being magnetized or attracted by a magnet) block or mass of material coupled to or integral with the upper mold half 102. The lower locking components 144 can comprise a magnet (e.g., a permanent magnet and/or electromagnet) and can have a switch 126 operable to magnetize and demagnetize the magnet, thereby holding and releasing the mold halves 102, 104 together. In alternative embodiments, the magnetic locking components can be positioned in opposite mold halves than described above. For example, in one such embodiment, the upper locking component can comprise a magnet and the lower locking component can comprise a ferrous mass of material. In some embodiments, both the upper and lower locking components 142, 144 can comprise magnets.

Upper locking components 142 and lower locking components 144 can be complementary to each other to engage with one another. For example, as shown in FIG. 1, the lower locking components 144 can be designed with valleys or ridges. The upper locking components 142 can be designed with corresponding protruding features that engage with the features of the lower locking components 142. Alternatively, as shown in FIG. 1, the upper locking components 142 can have a simple flat face that engages with the lower locking components 144.

In some embodiments, the magnetic locking component 120 can be a permanent magnet component. For example, a permanent magnet such as a spherical or other shaped magnet can be housed inside of a container (e.g., the lower locking component 144). Rotation of either the magnet itself within the container, or the container and magnet together, back and forth by 90 or 180 degrees can effectively direct magnetic force in one desired direction or another. In one specific example, the magnet can be a spherical magnet and the container can be a hollow cube-shaped box. A switch 126 can be included to mechanically turn the magnet to the proper orientation. For example, manual operation of the switch 126 (e.g., turning the switch 126 to an “on” position) can rotate a magnet inside the lower locking component 144 such that it directs magnetic force to attract the upper locking component 142 of the upper mold half, thereby applying a holding force keeping the mold halves 102, 104 pressed together and engaged with one another. The switch 126 (and thereby, the magnetic force) can be turned on at an appropriate time during the process, such as at an assembly station (e.g., when the mold halves are assembled together) and left on for any desired period of time, thus continuing to hold the mold halves together. Turning the switch 126 to an “off” position can rotate the magnet of lower locking component 144 such that it no longer attracts the upper locking component 142, thereby releasing the mold halves 102, 104 and allowing removal of the cast part from the cavities 116, 118. The switch 126 (and thereby, the magnetic force) can be turned off at an appropriate time during the process, such as at a demolding station (e.g., when the mold halves are disassembled and the cast part removed).

Alternatively, the magnetic locking components 120 can be electromagnetic components in some embodiments. In these embodiments, a metal component containing a metal coil can be magnetized by an electric power source. For example, switch 126, which can be positioned in or on either the upper locking component 142 or the lower locking component 144 (shown as a part of the lower locking component 144 in FIGS. 1-3), can be in electrical communication with a power supply, such as an electrical power source or a battery. Moving the switch 126 to an “on” position can supply electric current to the metal coil within, for example, the lower locking component 144, thereby magnetizing the coil and directing a magnetic force towards the upper locking component 142 which can be, for example, an armature plate 142. As with the permanent magnet embodiments, this magnetic force can attract the upper locking component 142 and upper mold half 102 towards the lower mold half 104, thereby causing upper and lower mold faces 108, 112 to engage with one another. In this manner, the electromagnetic locking components 120 can supply the holding force necessary to hold mold halves 102, 104 together during the casting process. Turning the switch 126 to an “off” position can demagnetize the coil within lower locking component 144, thereby allowing separation of the mold halves 102, 104 and removal of the cast part (e.g., the golf ball).

Some embodiments of cavity molds that include magnetic locking components such as those described above can have a reduced profile as compared to conventional cavity molds, due at least in part to the magnetic locking components being simplified and slimmer than conventional mechanical locking mechanisms. Furthermore, some embodiments of the described magnetic locking mechanism can allow for a greater area of the mold to participate in applying the locking force (e.g., the magnet can attract and pull one entire cavity plate towards the other) than can be accomplished with prior art mechanical locking mechanisms, thereby distributing the forces more evenly and reducing product defects in some embodiments. Use of cavity molds with magnetic locking mechanisms as herein described can also reduce processing times due to ease of locking and unlocking the mold halves as compared to conventional molds. Additionally, the reduced bulk of the mold resulting from the slimmer profile can advantageously result in faster cooling times and less energy requires for cooling. Finally, prior art mechanical locking mechanisms can be complicated designs, requiring a significant amount of maintenance. The simplified magnetic locking designs described herein can allow for easier handling and maintenance of the cavity molds implementing such magnetic locking components.

Still with reference to FIGS. 1-3, proper alignment of the two mold halves 102, 104 can help to ensure that products formed in the mold cavities are essentially free from defects in some embodiments. For example, the recesses 110 in the lower mold half 104 can be configured to correspond to the projecting pegs 106 on the upper mold half 102, such that when the upper and lower mold halves 102, 104 are engaged with one another, the upper and lower cavities 116, 118 are aligned with one another (e.g., concentric). In this arrangement, the mold faces 108, 112 are positioned in contact or close proximity with one another, and the projecting pegs 106 can be inserted into the recesses 110. The recesses 110 and projecting pegs 106 can thus help to ensure proper alignment of the upper and lower mold halves 102, 104 with one another. In the embodiment shown in FIG. 1, the projecting pegs 106 or recesses 110 is positioned near each of the four corners of the mold halves 102, 104, but other positions can also be used.

In alternative embodiments, rather than providing projecting pegs on the upper mold half and recesses on the lower mold half, the opposite arrangement can be provided (e.g., the upper mold half can comprise one or more recesses and the lower mold half can comprise one or more projecting pegs). In some embodiments, each of the upper and lower mold halves can comprise at least one projecting peg and at least one recess (e.g., each mold half can comprise a combination of projecting pegs and recesses). In other embodiments, other means of alignment can be used in addition to or instead of projections and recesses. For example, the mold halves can be aligned using external structures, ridges and valleys, contours, markings, and/or any other suitable alignment means.

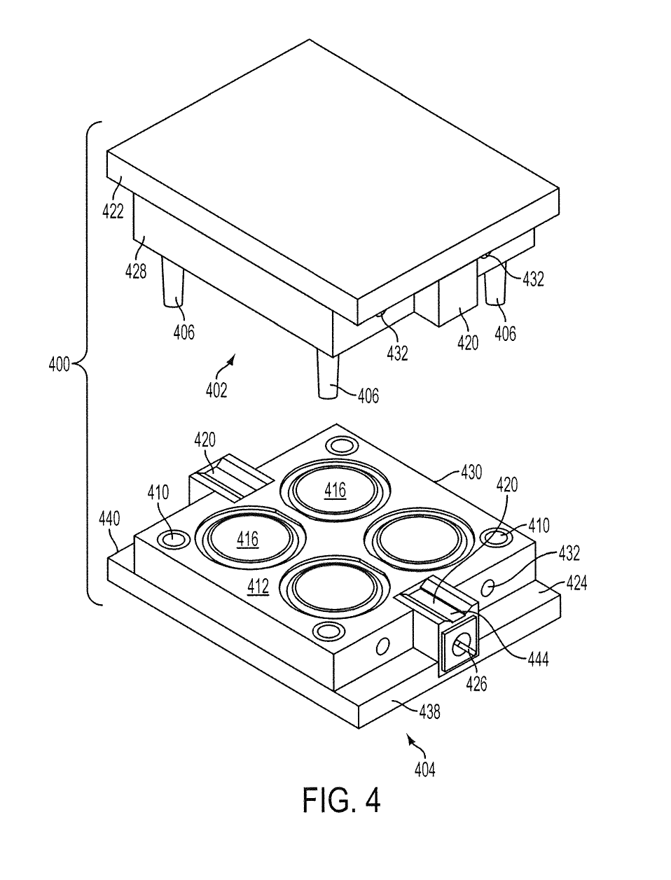

While FIGS. 1-3 illustrate a single cavity mold, other embodiments can comprise multiple cavities. For example, disclosed embodiments of magnetic locking molds can comprise between 1 and 12 cavities. In some embodiments, the mold can comprise more than 12 cavities. In some embodiments, the mold can comprise between 2 and 10 cavities. In some embodiments, the mold can comprise between 4 and 8 cavities. For example, FIGS. 4-8 show a multi-cavity mold 400 comprising four cavities.

FIG. 4 illustrates an exploded perspective view of a multi-cavity mold 400 that includes an upper mold half 402 and a lower mold half 404. The multi-cavity mold 400 is similar to the previously described single cavity mold of FIGS. 1-3, with the main difference being the number of cavities in each mold half.

Similar to the single cavity mold 100 shown in FIGS. 1-3, the multi-cavity mold 400 includes an upper mold half 402 that engages with a lower mold half 404. In the embodiment shown, the mold halves 402, 404 engage with one another via projections 406 extending from the mold face 408 of the upper mold half 402; the projections 406 are configured to be inserted into corresponding recesses, or holes, 410 formed in the mold face 412 of the lower mold half 404. As described above, this specific configuration of projections and recesses is exemplary and many other means of aligning and engaging the mold halves 402, 404 are possible.

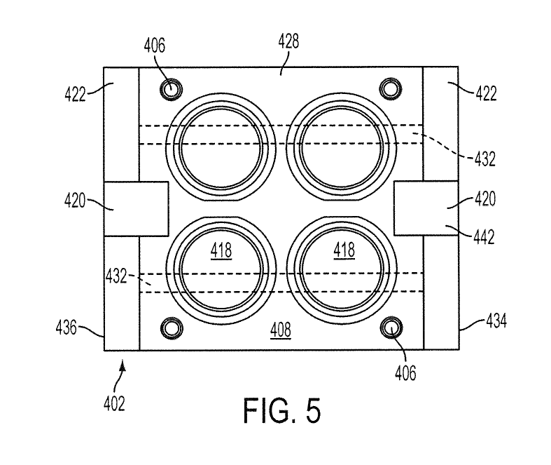

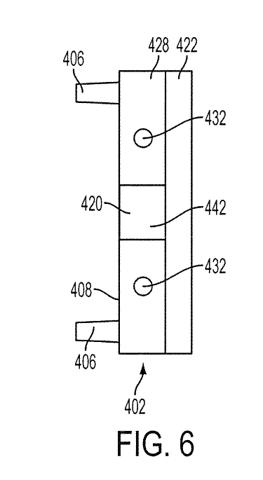

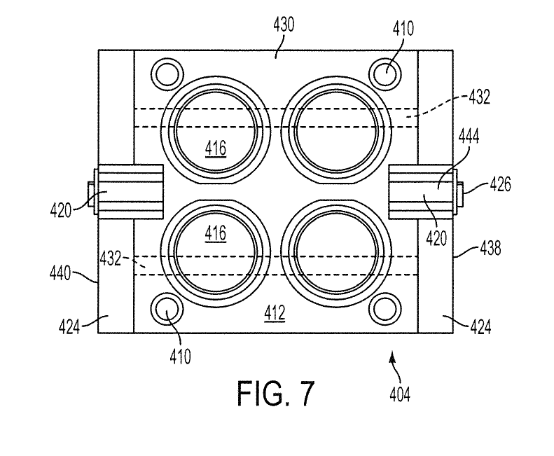

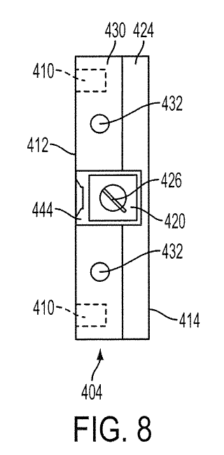

As best seen in FIGS. 5-6, the upper mold half 402 can be formed by an upper cavity plate 428 and an upper mold plate 422. The upper cavity plate 428 and the upper mold plate 422 can be coupled together (e.g., adhered, welded, secured via one or more fasteners, or otherwise coupled together), or formed as an integral body (e.g., machined from a single piece of metal). As best seen in FIGS. 7-8, the lower mold half 404 can be formed by a lower cavity plate 430 and a lower mold plate 424. The lower cavity plate 430 and the lower mold plate 424 can be coupled together (e.g., adhered, welded, secured via one or more fasteners, or otherwise coupled together), or formed as an integral body (e.g., machined from a single piece of metal).

Upper mold half 402 includes, in this embodiment, four upper cavities 418 and lower mold half 404 includes four lower cavities 416. When the upper and lower mold halves are engaged with one another, the upper cavities 418 are aligned with the lower cavities 416 so as to faun four substantially spherical cavities, whereby a golf ball can be formed in each of the substantially spherical cavities during a casting molding process. Of course, in other embodiments, different sized and shaped cavities can be used to form different objects or parts via other casting processes. In other words, while the illustrated embodiments show hemispherical cavities in each mold half, the disclosure is not limited in this respect.

Upper and lower mold halves 402, 404 can also include, in some embodiments, one or more cooling channels 432. The cooling channels 432 can be formed, for example, in the upper cavity plate 428 and/or in the lower cavity plate 430. For example, one or more cooling channels 432 can be formed in the upper cavity plate 428 such that they extend substantially in the same plane as the upper cavity plate 428 and positioned within the thickness of the upper cavity plate 428 (e.g., between the mold face 408 and the upper mold plate 422). Similarly, one or more cooling channels 432 can be formed in the lower cavity plate 430 such that they extend substantially in the same plane as the lower cavity plate 430 and positioned within the thickness of the lower cavity plate 430 (e.g., between the mold face 412 and the lower mold plate 424).

In some embodiments, one or more longitudinal cooling channels 432 can extend at least substantially between a first end 434 and a second end 436 of the upper mold half 402 and/or at least substantially between a first end 438 and a second end 440 of the lower mold half 404. The cooling channels 432 can be configured to receive one or more cooling fluids, such as a cooling liquid or gas (e.g., air), that can serve to cool the material within the upper cavities 416 and/or the lower cavities 418. In some embodiments, the cooling fluid can be a pressurized gas, such as compressed air. The cooling fluid can be kept at a lower temperature than the mold is during processing, and thus can serve to cool the mold when introduced into the cooling channels.

In some embodiments, one or more of the cooling channels 432 can be positioned such that they pass between adjacent rows of cavities. In some embodiments, one or more of the cooling channels 432 can be positioned such that they pass beneath the center point of the cavities 416, 418. In some embodiments, one or more of the cooling channels can be positioned such that they pass under the cavities 416, 418 at a point away from the center point.

In some embodiments, the cooling channels 432 can have narrow entrance channels near the mold half ends 434, 436, 438, 440, with the entrance channels opening into a larger cooling area positioned under and around the cavities 416, 418. For example, the cooling channels can allow cooling fluid to substantially surround at least part of the inner surface of the cavities 416, 418, pooling or flowing between the mold face 408, 412 and the upper mold plate 422 or lower mold plate 424, respectively.

The upper and lower mold halves 402, 404 of the multi-cavity mold 400 can be held together during use by magnetic locking components 420. Magnetic locking components 420 can be, for example, components of a permanent magnet or electromagnetic system, or combinations thereof. For example, the upper locking component 442 and the lower locking component 444 can be permanent magnets with complementary polarity such that the upper and lower locking components 442, 444 are magnetically attracted to one another. In other embodiments, upper and lower locking components 442, 444 can be electromagnetic components configured to engage with one another, with the electromagnetic force being activated and deactivated by a switch 426.

While the process details are not critical for this disclosure (e.g., disclosed electromagnetic molds can be used with many different casting processes), by way of example, one simplified process can be described as follows. Material can be dispensed into the cavities at an assembly station. Then, the mold can be closed and locked via, for example, electromagnetic or permanent magnet locking components as described above. The holding force can vary depending on the strength of the magnetic components, and can be increased or decreased as desired or necessary for the particular application. Applied mold holding forces for described permanent magnetic or electromagnetic locking embodiments can range from about 100 to about 3,000 psi. In some embodiments, the applied holding force can range from about 200 to about 2,000 psi. In preferred embodiments, the holding force applied by the magnetic locking system can range from about 300 to about 1,200 psi.

The molds can then be heated and cured in an oven, followed by a cooling process, such as by inserting the molds into a cooling tunnel and/or flowing cooling fluid through one or more cooling channels within the mold. Finally, the magnetic locking mechanism can be released (e.g., demagnetized), the mold opened, and the balls (or other product) released from the mold.

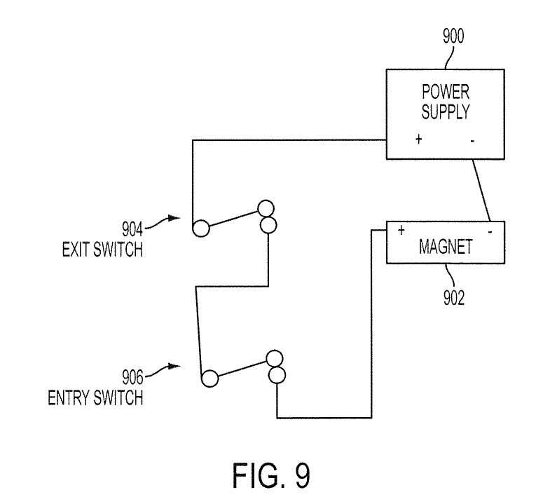

FIG. 9 shows a block diagram of a system for operating an electromagnetic cavity mold (e.g., mold 400 of FIGS. 4-8). A battery or other power supply 900 can provide power for a magnet 902 which can be used to hold the two mold halves together when necessary (e.g., between an assembly station and a demolding station). An entry switch 906 can be mounted at a mold assembly station and an exit switch 904 can be mounted at a demolding station.

The power supply 900 (e.g., an electric power source or battery) can magnetize coils inside a metal component (e.g., lower magnetic locking components 442). An electromagnet can be mounted on the lower mold half (e.g., in or on the lower cavity plate or lower mold plate), while an armature plate can be mounted on the upper mold half (e.g., in or on the upper mold plate or upper cavity plate). When the magnet is connected to the power supply 900, the mold is effectively locked by the attraction of the electromagnet to the armature plate.

In embodiments where the locking components include one or more permanent magnets, a spherical magnet can be housed inside a box, or container having an on/off switch. Mechanical or manual operation of the switch can, in some embodiments, rotate the spherical magnet by 90 or 180 degrees such that the magnet will direct magnetic force in one desirable direction. For example, when the switch is in the “on” position, the spherical magnet can be positioned such that its magnetic force holds the two mold halves together. When the switch is in the “off” positioned, the spherical magnet can be rotated such that it no longer holds the mold halves together magnetically.

Described embodiments of either electromagnetic or permanent magnetic locking components can be advantageously positioned along the outer edges of the mold halves, away from the center of the mold and away from the centers of the cavities. This positioning can more evenly distribute the mold holding force as compared to conventional locking mechanisms, thereby decreasing defects in the golf balls or other parts produced, in some embodiments.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A mold for use in a casting process, the cavity mold comprising:
an upper cavity plate comprising at least one upper cavity formed therein and at least one upper magnetic locking component;
a lower cavity plate configured to engage with the upper cavity plate, the lower cavity plate comprising at least one lower cavity formed therein and at least one lower magnetic locking component, wherein the upper and lower magnetic locking components are configured to hold the upper and lower cavity plates together.

2. The mold according to claim 1, wherein the cavity mold is configured for use in a urethane casting process.

3. The mold according to claim 1, wherein the cavity mold is a single cavity mold.

4. The mold according to claim 1, wherein the cavity mold is a multi-cavity mold.

5. The mold according to claim 1, wherein the upper cavity and the lower cavity are hemispherical cavities configured to produce a golf ball.

6. The mold according to claim 1, further comprising at least one cooling channel configured to receive a cooling fluid and to cool the upper and/or lower cavities.

7. The mold according to claim 6, wherein the upper cavity plate comprises at least one cooling channel and the lower cavity plate comprises at least one cooling channel.

8. The mold according to claim 7, wherein the cooling channels extend from a first end to a second end of each of the upper and lower cavity plates.

9. The mold according to claim 1, wherein magnetic locking components are positioned near the periphery of the upper and lower cavity plates.

10. The mold according to claim 1, further comprising a switch configured to magnetize and demagnetize the magnetic locking components.

11. The mold according to claim 1, wherein the upper cavity plate comprises one or more projecting pegs and/or recesses.

12. The mold according to claim 11, wherein the lower cavity plate comprises one or more projecting pegs and/or recesses.

13. The mold according to claim 1, wherein the upper cavity plate comprises at least one projecting peg and the lower cavity plate comprises at least one recess configured to receive the at least one projecting peg.

14. The mold according to claim 1, wherein the upper and/or lower magnetic locking components are permanent magnetic locking components.

15. The mold according to claim 1, wherein the upper and/or lower magnetic locking components are electromagnetic locking components.

16. A method for performing a urethane casting process comprising:
providing an upper mold half, the upper mold half comprising at least one upper cavity and at least one upper magnetic locking component;
providing a lower mold half, the lower mold half comprising at least one lower cavity and at least one lower magnetic locking component; and
magnetizing the upper magnetic locking component and/or the lower magnetic locking component, thereby holding the upper mold half and lower mold half in engagement with one another for a period of time sufficient for the casting process.

17. The method according to claim 17, wherein magnetizing the upper and/or lower magnetic locking components comprises turning a switch and delivering current to an electromagnetic coil.

18. The method according to claim 17, wherein magnetizing the upper and/or lower magnetic locking components comprises turning a switch and rotating a spherical permanent magnet.

19. The method according to claim 17, wherein magnetizing is performed at an assembly station and wherein the method further comprising demagnetizing the upper and/or lower magnetic locking components, thereby releasing the mold halves, wherein the demagnetizing is performed at a demolding station.
